(19) United States
(12) Patent Application Publication
(10) Pub. No.: US 2013/0115001 A1
(43) Pub. Date: May 9, 2013

(54) RELEASABLY MOUNTED SCRAPER

(71) Applicant: Caleb D. Von Vett, Minneapolis, MN (US)

(72) Inventor: Caleb D. Von Vett, Minneapolis, MN (US)

(73) Assignee: Caterpillar Paving Products Inc., Minneapolis, MN (US)

(21) Appl. No.: 13/292,176

(22) Filed: Nov. 9, 2011

(51) Int. Cl. A01B 29/06; E02D 3/026; E01C 19/26

(52) U.S. Cl. 404/129; 172/518

(57) ABSTRACT

A scraping arrangement including a pair of linkage arms mounted at a one end to a frame. The pair of linkage arms is pivotally mounted to the frame. The scraping arrangement also includes a scraper supported at a free end of the pair of linkage arms. Further, a retaining member is provided to releasably secure the pair of linkage arms along with the scraper to the frame.

### TECHNICAL FIELD

The present disclosure relates to a compactor machine, and particularly to a scraper arrangement for the compactor machine.

### BACKGROUND

Compactors for either soil or asphalt tend to collect residue on the compacting member, such as a drum, due to adhesion. Scrapers are provided to remove the collected residue from the surface of the compacting member. Typically, the scraper is rigidly attached to a frame of the compactor and positioned sufficiently far from the compacting member. Sometimes, a biasing member, such as a spring, may be used to bias the scraper against the surface of the compacting member.

U.S. Pat. No. 3,802,339 discloses an apparatus for continuously cleaning the surface of the compacting member, particularly a vibratory compacting member. The apparatus includes a support pivoted at one end to the frame and a scraper is provided adjacent to the other end of the support. The scraper is adapted to engage and clean the surface of the compacting member. For effective scraping, the scraper is maintained in contact with the drum by a tension spring coupled between the support and the frame.

### SUMMARY

In one aspect, the present disclosure provides a scraping arrangement. The scraping arrangement is adapted to be mounted on a frame. The scraping arrangement includes a pair of linkage arms pivotally mounted at a one end to the frame. The scraping arrangement also includes a scraper supported at a free end of the pair of linkage arms. Further, a retaining member is provided to releasably secure the pair of linkage arms to the frame.

In another aspect, the present disclosure provides a machine. The machine includes a frame. The machine also includes a compacting member rotatably supported by the frame. Further, a pair of linkage arms is pivotally mounted at a one end to the frame. The machine also includes a scraper supported at a free end of the pair of linkage arms. The scraper is in spatial relationship with the compacting member. The machine further includes a retaining member configured to releasably secure the pair of linkage arms to the frame.

In yet another aspect, the present disclosure provides a scraping arrangement for a machine in which the machine have a frame and a compacting member rotatably supported by the frame. The scraping arrangement includes a pair of linkage arms pivotally mounted at a one end to the frame. The scraping arrangement also includes a scraper in a spatial relationship with the compacting member. The scraper is slidably attached to the pair linkage arms at a free end of the pair of linkage arms. The scraping arrangement further includes a retaining member. The retaining member is configured to releasably secure the pair of linkage arms to the frame. The retaining member is further configured to collapse in case of excess forces to allow the scraper to fall back along with the pair of linkage arms by swinging free about the pivot.

Other features and aspects of this disclosure will be apparent from the following description and the accompanying drawings.

### BRIEF DESCRIPTION OF THE DRAWINGS

FIG. 1 illustrates a perspective view of a machine, according to an aspect of the present disclosure; and

FIG. 2 illustrates a diagrammatic view of a scraping arrangement for the machine of FIG. 1.

### DETAILED DESCRIPTION

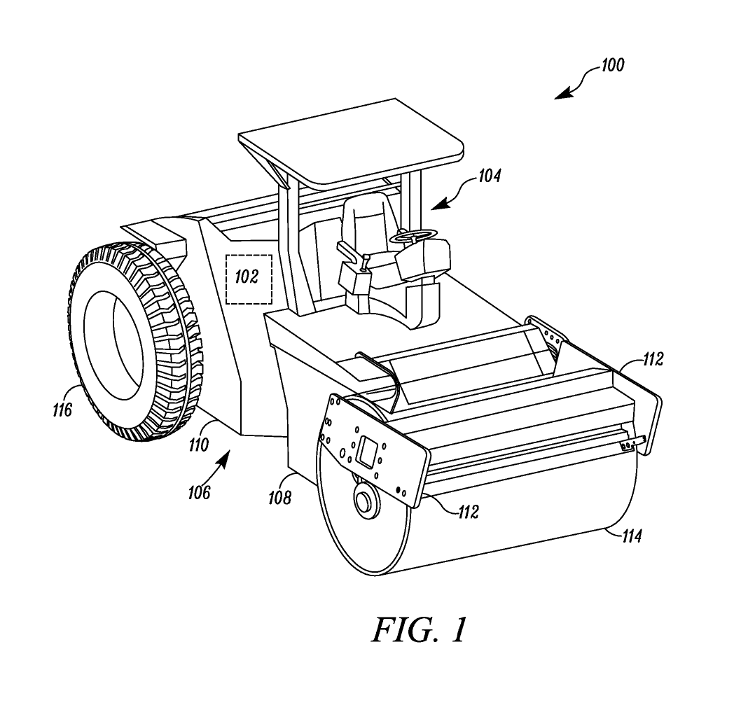

The present disclosure will now be described in detail with reference being made to accompanying figures. A machine 100 in which disclosed embodiments may be implemented is schematically illustrated in FIG. 1. As illustrated in FIG. 1, the machine 100 embodies a vibratory soil compactor. In various other embodiments, the machine 100 of the present disclosure may be a soil compactor, an asphalt compactor, a landfill compactor, a vibratory asphalt compactor, a pneumatic tire compactor or the like.

The machine 100 includes a power source 102 for driving the various components. The power source 102 may include an internal combustion engine. The internal combustion engine may be, without any limitation, a gasoline or diesel engine, a natural gas engine, and the like. The machine 100 may further include an operator station 104 having one or more control means to control the various machine operations. The machine 100 includes a frame 106 to support various structures. The frame 106 may include a front section 108 and a rear section 110. Further, the frame 106 may include a pair of longitudinally opposite side members 112 extending outwardly from the front section 108.

The machine 100 includes a compacting member 114 supported by the frame 106. Specifically, the compacting member 114 may be rotatably supported by the front section 108 of the frame 106. In an embodiment, the compacting member 114 may be in the shape of a roller or a drum disposed between the side members 112. However it may be contemplated, in alternative embodiments, the compacting member 114 may include threaded tires or the like. Further, the machine 100 may include a set of traction wheels 116 mounted on the rear section 110. In an alternative embodiment, instead of the set of traction wheels 116, another drum or roller may be disposed at the rear section 110. Together, the compacting member 114 and the set of traction wheels 116 act as the ground engaging member for the machine 100.

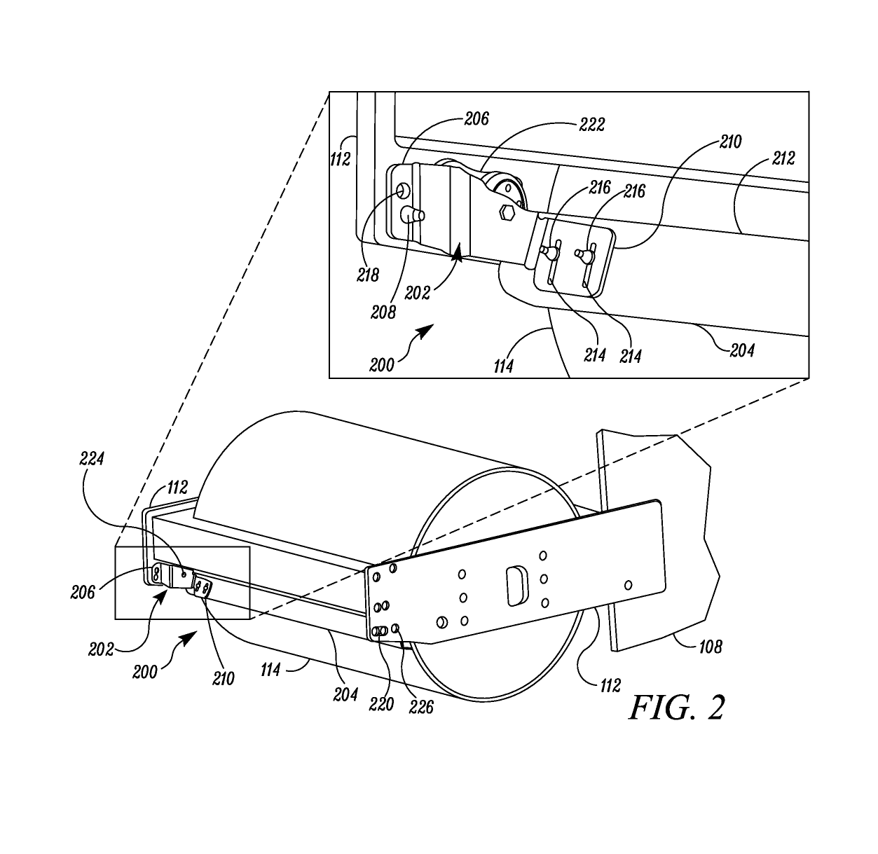

Referring to FIG. 2, a scraping arrangement 200 is mounted on the front section 108 of the frame 106. The scraping arrangement 200 is configured to remove and clean the residual material that sticks on the compacting member 114 during the operation. It may be apparent to a person skilled in the art that the scrapping arrangement is symmetrical about a centre line of the compacting member 114, and the present disclosure will be described with reference to only one side of the scraping arrangement 200. In an embodiment, the machine 100 may also include another scraping arrangement mounted on a rear side of the compacting member 114.

The scraping arrangement 200 includes a pair of linkage arms 202, and a scraper 204. For illustration purpose, only one linkage arm 202 of the pair of linkage arms 202 is illustrated. The linkage arm 202 is mounted from a one end 206 to the frame 106. Specifically, the pair of linkage arms 202 may be mounted to the side member 112 of the frame 106. The pair of linkage arms 202 may be pivotally mounted to the frame 106 by a fastening member 208, such as a combination of a nut and a bolt.

In the scraping arrangement 200, the scraper 204 may be supported at a free end 210 from the pair of linkage arms 202. The scraper 204 may be made of any suitable material like iron, plastic, alloys like steel, etc. Typically, the scraper 204 includes a scraping edge 212 in a spatial relationship with the compacting member 114 of the machine 100. The scraping edge 212 may be arcuate to align with a curved surface of the compacting member 114.

In an embodiment, the linkage arm 202 may include one or more slots 214 defined at the free end 210. Further, the scraper 204 includes holes (not illustrated) corresponding to the slots 214. One or more locking members 216, which typically is a combination of a nut and a bolt, may pass through the slot 214 and the holes to support the scraper 204 to the linkage arm 202. The scraper 204 may be adjustable by moving the nut through the slots 214 and later on locking it with a bolt. This allows varying the distance between the scraping edge 212 and the compacting member 114 in the machine 100.

In an embodiment of the present disclosure, each linkage arm 202 of the pair of linkage arms 202 may include two or more adjustment holes 218 to mount the linkage arm 202 to the side member 112. Correspondingly, holes 220 may be provided on the side member 112 to receive the fastening member 208 through the adjustment holes 218 and holes 220. These adjustment holes 218 may allow varying the angular position of the pair of linkage arms 202, and thus of the scraper 204, with respect to the compacting member 114.

Further, the scraping arrangement 200 may include a retaining member 222 disposed between the linkage arm 202 and the side members 112 of the frame 106. In FIG. 2, a part of the linkage arm 202 is sectioned to illustrate the retaining member 222. The retaining member 222 of the present disclosure may be an isolation mount. Further, the retaining member 222 may be made of any elastomeric material like rubber.

Based on geometry changes and application of the scraping arrangement 200, the stiffness of the retaining member 222 may vary. According to one embodiment, the retaining member 222 may have stiffness in the range of approximately 50-300 N/mm. According to another embodiment, the stiffness of the retaining member 222 may vary between 180-230 N/mm. In an exemplary embodiment, the retaining member 222 may be configured to have stiffness of approximately 189 N/mm. In another exemplary embodiment, the retaining member 222 may be configured to have stiffness of approximately 228 N/mm.

The retaining member 222 may releasably secure the linkage arm 202 to the side members 112. The retaining member 222 may be disposed between a first set of apertures 224 in the linkage arm 202 and a second set of apertures 226 provided on the side members 112. The retaining member 222 may include corresponding indents, aligned with the first and the second set of apertures 224, 226. Further, a pair of holding members, such as a bolt, screw or the like, may pass through the apertures 224, 226 and the corresponding indents to mount the retaining member 222 between the linkage arm 202 and the side member 112. Alternatively, protruding portions may be provided on the retaining members 222, and this help in supporting the retaining member 222 between the first and the second set of apertures 224 and 226. According to an aspect of the present disclosure, in case of excess forces, the retaining member 222 may collapse allowing the pair of linkage arms 202 to swing freely about the side members 112.

Typically, the scraping arrangement 200 may also include resilient means to engage the scraper 204 to a scraping engagement with the compacting member 114. In an embodiment, the retaining member 222 of the present disclosure may also act as the resilient means for the scraping arrangement 200. In other embodiments, the scraping arrangement 200 is provided with a tension spring to keep the scraper 204 biased towards the compacting member 114. Further, the scraping arrangement 200 may include restraining means (not illustrated) to limit a rotary or a lateral movement of the scraper 204 in relation to the compacting member 114.

### INDUSTRIAL APPLICABILITY

In operation, some residue like soil or asphalt tends to collect on the surface of the compacting member 114 due to adhesion. In order to provide efficient working of the machine 100, the collected residue needs to be continuously removed from the surface of the compacting member 114. When the residue accumulates on the surface of the compacting member 114, the operator from the operator station 104 commands to raise the scraper 204 form its resting position.

To remove the residue, the scraper 204 is disposed in a spatial relationship to the compacting member 114. The resilient means may engage the scraper 204 to the scraping engagement with the compacting member 114. In particular, the scraping edge 212 may be position in a sufficient distance from the surface of the compacting member 114 to scrap off the collected residue. To avoid the build up and ensure that the scraped-off residue fall clear of the compacting member 114, the scraper 204 is supported from the free ends 210 of the pair of linkage arms 202.

To compensate for the wear of the scraping edge 212 because of prolonged usage, the space between the scraper 204 and the compacting member 114 may be varied. This is achieved by sliding the locking member 216 along the slots 214. In addition, the angular position of the scraper 204 may be varied relative to the compacting member 114 by mounting the pair of linkage arms 202 to different adjustment holes 218.

As the residue is scraped off the compacting member 114, some of the residue may be accumulated over the scraper 204. In conventional machines, this leads to passing of excess forces to the scraper, which may break the scraper from the pair of linkage arms 202. This may also lead to complete damage of the scraper 204 with the machine 100 passing over. However in the machine 100 of the present disclosure, the provided retaining member 222 may collapse in case of the excess forces. This allows the scraper 204 to swing free about the side members 112 and fall back along with the pair of linkage arms 202 to hang clear of the compacting member 114.

Further in case of fall back of the scraper 204, the restraining means may be provided in the scraping arrangement 200. The restraining means may limit the rotary or the lateral movement of the scraper 204. This prevents the scraper 204 to swing back towards and strike the compacting member 114 to avoid further damage.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A scraping arrangement adapted to be mounted to a frame, the scraping arrangement comprising:
pair of linkage arms configured to be pivotally mounted to the frame;
a scraper supported at a pivotally free end of the pair of linkage arms; and
at least one retaining member configured to releasably secure the pair of linkage arms in a first position relative to the frame,
wherein when the retaining member is secured to the pair of linkage arms the linkage arms are maintained in the first position relative to the frame, and when the linkage arms are released from the retaining member the linkage arms pivot to a second position relative to the frame while remaining attached to the frame.

2. The scraping arrangement of claim 1, wherein the linkage arms includes a slot defined at the free end, and wherein the scraper includes a hole corresponding to the slot.

3. The scraping arrangement of claim 1, wherein a fastening member passes through the slot and the hole to slidably support the scraper to the pair of linkage arms.

4. (canceled)

5. The scraping arrangement of claim 1, wherein the retaining member is an isolation mount made of rubber.

6. The scraping arrangement of claim 5, wherein a stiffness of the retaining member is in the range of approximately 50-300 N/mm.

7. The scraping arrangement of claim 6, wherein the stiffness of the retaining member in the range of approximately 180-230 N/mm.

8. The scraping arrangement of claim 1, wherein the retaining member is disposed between a first set of apertures in the pair of linkage arms and the frame.

9. The scraping arrangement of claim 1, wherein the retaining member is configured to decouple from the pair of linkage arms when a predetermined force is applied thereto through the pair of linkage arms.

10. A machine comprising:
frame;
compacting member rotatably supported by the frame;
a pair of linkage arms pivotally mounted to the frame;
scraper supported at a pivotally free end of the pair of linkage arms; and
at least one retaining member configured to releasably secure the pair of linkage arms in a first position relative to the frame,
wherein when the retaining member is secured to the pair of linkage arms the linkage arms are maintained in the first position relative to the frame, and when the linkage arms are released from the retaining member the linkage arms pivot to a second position relative to the frame while remaining attached to the frame.

11. The machine of claim 10 is a vibratory soil compactor.

12. The machine of claim 10, wherein the linkage arms includes a slot defined at the free end, and wherein the scraper includes a hole corresponding to the slot.

13. The machine of claim 12, wherein a fastening member passes through the slot and the hole to slidably support the scraper to the pair of linkage arms.

14. The machine of claim 10, wherein the frame includes two or more adjustment holes to which the pair of linkage arms pivotally mounts.

15. The machine of claim 10, wherein the retaining member is an isolation mount made of rubber.

16. The machine of claim 15, wherein a stiffness of the retaining member is in the range of approximately 50-300 N/mm.

17. The machine of claim 10, wherein the retaining member is disposed between a first set of apertures in the pair of linkage arms and a second set of apertures in the frame.

18. The machine of claim 10, wherein the retaining member is configured to decoupled from the pair of linkage arms when a predetermined force is applied thereto through the pair of linkage arms.

19. A scraping arrangement for a machine, the machine having a frame and a compacting member rotatably supported by the frame, the scraping arrangement comprising:
a pair of linkage arms pivotally mounted at a one end to the frame;
a scraper configured to be spaced apart from the compacting member, the scraper being slidably attached to the pair of linkage arms at a pivotally free end of the pair of linkage arms; and
a retaining member configured to releasably secure the pair of linkage arms to the frame,
wherein when the retaining member is secured to the pair of linkage arms the linkage arms are maintained in the first position relative to the frame, and when the linkage arms are released from the retaining member the linkage arms pivot to a second position relative to the frame while remaining attached to the frame.

20. The scraping arrangement of claim 19, wherein the retaining member is an isolation mount made of rubber.

21. The scraping arrangement of claim 1, further comprising a pair of pivot attachments respectively connecting the pair of linkage arms to the frame, each of the pair of pivot attachments being disposed opposite to the scraper with respect to the retaining member.
